(19) United States
(12) Patent Application Publication
(10) Pub. No.: US 2005/0132011 A1
(43) Pub. Date: Jun. 16, 2005

(54) Method for managing interruptions to a network user

(75) Inventors: Michael J. Muller, Medford, MA (US); Daniel M. Gruen, Newton, MA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: International Business Machines Corporation, Armonk, NY (US)

(21) Appl. No.: 10/734,494

(22) Filed: Dec. 12, 2003

(51) Int. Cl. G06F 15/16; G06F 12/14; G06F 11/30; H04L 9/32; H04L 9/00

(52) U.S. Cl. 709/206; 713/200

(57) ABSTRACT

Described is a method for managing interruptions to a network user. The interruptions are generated by senders on a network. The network user maintains a permanent reception list and a temporary reception list indicating senders that are allowed preferential treatment in response to their interruptions. The temporary reception list is modified in response to a retrospective activity or a prospective activity. An interruption received from a sender is presented to the network user if the permanent reception list or the temporary reception list includes an entry associated with the sender of the interruption. In one embodiment, the interruption is presented to the network user if an associated urgency value exceeds an interruption threshold value defined by the network user. In another embodiment, a customized status message is generated if the permanent reception list or the temporary reception list includes an entry associated with the sender of a user status request.

### FIELD OF THE INVENTION

The invention relates generally to a method for managing interruptions to a network user. In particular, the invention relates to a method of controlling access to the network user according to user specified information and dynamic criteria.

### BACKGROUND

The electronic workplace of today is filled with many conveniences to allow employees to collaborate with each other. Some workplace environments allow employees to have ready access to each other through real time communications such as chat and instant messaging. In some instances a chat is initiated by selecting a sender, recipient or group of individuals identified in an e-mail. Alternatively, the chat can be initiated by selecting an author, individual or group associated with a shared document. Thus users can quickly communicate with other employees to pose questions to topics of common interest.

Under many circumstances chat can increase employee efficiency. However, in large organizations where employees have broad access to other employees, an employee can experience a large volume of chats, particularly if the employee possesses unique skills or expertise recognized by a large number of other employees. These chats, or interruptions, can hinder the employee's ability to perform their required workplace tasks or projects. If the employee is busy, the interruptions can be ignored. However, some of the interruptions can relate to high priority matters that the employee needs to address.

What is needed is a method for managing interruptions to the user. The method should prevent general work disruptions of the user without obstructing access to important interruptions. The present invention satisfies this need and provides additional advantages.

### SUMMARY OF THE INVENTION

In one aspect, the invention features a method for managing interruptions to a network user. The interruptions are generated by senders on a network and the network user has a permanent reception list. A temporary reception list is modified in response to a retrospective activity or a prospective activity. An interruption is received from one of the senders and presented to the network user if the permanent reception list or the temporary reception list includes an entry associated with the sender of the interruption.

In one embodiment, an urgency value associated with the interruption is received and compared with an interruption threshold value defined by the network user. The interruption is presented to the network user if the urgency value exceeds the threshold value. In another embodiment, a user status request is received from one of the senders. If at least one of the permanent reception list and the temporary reception list includes an entry associated with the sender of the user status request, a customized status message is generated. If the permanent reception list and the temporary reception list do not include an entry associated with the sender of the user status request, a generic status message is generated.

In another aspect, the invention features a computer program product for use with a computer system. The computer program product includes a computer useable medium having embodied therein program code. The program code includes program code for modifying a temporary reception list of a network user in response to a retrospective activity or a prospective activity, program code for receiving an interruption from a sender on the network, and program code for presenting the interruption to the network user if the temporary reception list or a permanent reception list of the network user includes an entry associated with the sender.

In yet another aspect, the invention features a computer data signal embodied in a carrier wave for use with a computer system having a display and capable of generating a user interface through which a user may interact with the computer system. The computer data signal includes program code for modifying a temporary reception list of a network user in response to a retrospective activity or a prospective activity, program code for receiving an interruption from a sender on the network, and program code for presenting the interruption to the network user if the temporary reception list or a permanent reception list of the network user includes an entry associated with the sender.

In still another aspect, the invention features a computing system including a display screen, a user input device, and a processor. The processor executes a network user communications program to manage interruptions to a network user. The interruptions are generated by senders on a network. Each interruption is presented to the network user on the display screen if a permanent reception list or a temporary reception list includes an entry associated with the sender of the interruption.

In still another aspect, the invention features an apparatus for managing interruptions to a network user. The interruptions are generated by senders on a network and the network user has a permanent reception list. The apparatus includes means for modifying a temporary reception list in response to a retrospective activity or a prospective activity, means for receiving an interruption from one of the senders on the network, and means for presenting the interruption to the network user if the permanent reception list or the temporary reception list includes an entry associated with the sender of the interruption.

In one embodiment, the apparatus also includes means for receiving an urgency value associated with the interruption, means for comparing the urgency value with an interruption threshold value defined by the network user, and means for presenting the interruption to the network user if the urgency value exceeds the interruption threshold value. In another embodiment, the apparatus also includes means for receiving a user status request from one of the senders, means for generating a generic status message if the permanent reception list and the temporary reception list do not include an entry associated with the sender of the user status request, and means for generating a customized status message if the permanent reception list or the temporary reception list includes an entry associated with the sender of the user status request.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIG. 1 illustrates a networked communication environment in which an embodiment of a method for managing interruptions to a network user according to the invention can be implemented.

FIG. 2 is a flowchart representation of an embodiment of a method for modifying a temporary reception list in accordance with the invention

FIG. 3 is a summarization of the processing of interruption requests based on sender type and urgency value for an embodiment of a method for managing interruptions to a network user in accordance with the invention.

FIG. 4 is a summarization of the processing of interruption requests based on sender type and urgency value for another embodiment of a method for managing interruptions to a network user in accordance with the invention.

### DETAILED DESCRIPTION

In brief overview the invention relates to a method for managing interruptions to a user on a network. The term “interruptions” as used herein refers to any form of communication initiated by a sender and directed to the network user (hereafter “user”). By way of example, the interruption can be a chat message generated by the sender or any other form of electronic messaging that can be delivered over the network to the user. Typically, the interruption is visually presented to the user through a graphical user interface on a display screen and may be accompanied by an audible alert. The method includes various techniques for processing interruptions, including screening incoming interruptions according to one or more reception lists, queuing received interruptions prior to their presentation, determining an urgency of the interruption based upon sender and user information, and providing conditional status information regarding the user to the sender in response to a status request.

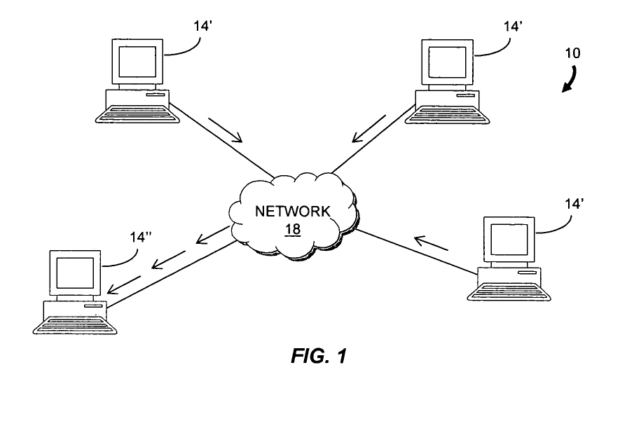

Referring to FIG. 1, a networked communication environment 10 includes users 14′ and 14″ (generally 14) communicating with each other over a network 18. Each user 14 accesses a local computer having a display screen and providing a user interface, including a user input device, through which the user 14 interacts with the local computer and other computers on the network 18. The network 18 can be implemented as a local area network (LAN), an intranet, the Internet or other form of network providing near real time communications between users 14. A user 14 can interrupt one or more other users 14 by proposing a chat. Similarly, a user 14 can interrupt other users 14 by attempting to add the other users to an ongoing chat session. Hereafter the term “sender” designates a user 14′ that generates the interruption. If no controls are implemented, a user 14″ can experience an overwhelming volume of interruptions. Consequently, the user 14″ may not be able to respond to all of the interruptions. Moreover, the user 14″ may not be able to perform other work related tasks.

To manage interruptions from senders 14′ on the network 18, a user 14 can maintain reception lists which identify individuals or groups of people from whom the user 14 is willing to accept chats and other interruptions. For example, chats proposed by senders 14′ whose names are included in the reception lists receive preferential treatment. Preferential treatment may include immediate access to the user 14″ so that the chat is allowed to interrupt the user 14″. Additionally, senders 14′ identified on the reception lists can receive other advantages described in more detail below, such as an increase in priority over interruptions from other senders 14′ and special awareness information in response to a user status request.

A reception list can be permanent or temporary. A permanent reception list is constructed using static or slowly varying information. Permanent reception lists can be populated by the user 14 according to individual preferences as is known in the art. For example, a permanent reception list can be populated according to an organizational list in which team members and management personnel are included but other members of the organization are absent. The user 14 can also include personal entries such as family members, friends and other workplace contacts that are not included as team members or management. Although described as permanent, it is to be understood that the permanent reception list can be updated on an occasional basis, such as when an organizational list is revised.

A temporary reception list is constructed according to users associated with retrospective and prospective activities. Retrospective activities include recently received asynchronous communications (i.e., communications without simultaneous participation between two or more users) via e-mail and other media, completed tasks and “to do” items, and the like. Prospective activities include imminent events such as scheduled meetings and items on “to do” lists with near term completion dates.

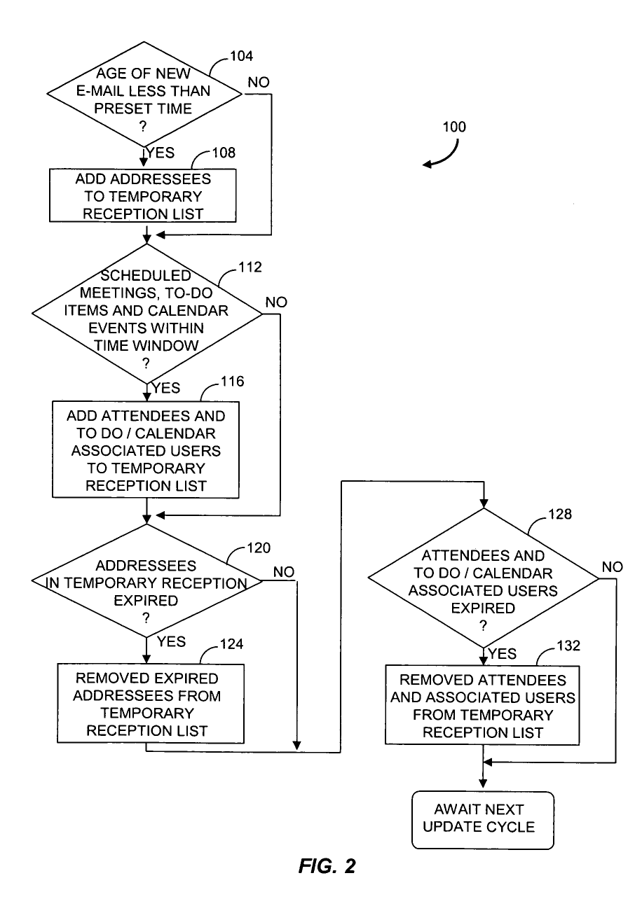

Users 14 are included and removed from temporary reception lists according to temporal criteria. FIG. 2 presents a flowchart representation of an embodiment of a method 100 for modifying a temporary reception list in accordance with the invention. The user's e-mail inbox and sent box can be examined to determine (step 104) addressees and senders included in e-mail received or sent within an established time interval (e.g., two days). Addressees and senders for e-mails within the acceptable time window are added (step 108) to the temporary reception list. Similarly, the user's calendar and “to do” list can be examined to determine (step 112) meetings scheduled within a definite time period (e.g., the next week). The attendees for these meetings and users associated with the “to do” list are added (step 116) to the temporary reception list.

Similarly, the temporary reception list can be automatically updated to remove aged entries. If it is determined (step 120) that the age of an e-mail exceeds the established time interval, the associated addressees are removed (step 124) from the reception list if there are no other retrospective or prospective activities that qualify them for inclusion. Similarly, when it is determined (step 128) that users associated with “to do” lists and meetings that are more than a predetermined time beyond the effective dates, the associated users are dropped (step 132) from the temporary reception lists unless they are included in other qualifying activities.

The time windows for retrospective activities and prospective activities are user defined and can be changed according to the workload or other preference of the user. The entry of users into the temporary reception list is automatic. Modification of the temporary reception list occurs regularly, such as once an hour or on a daily basis. Optionally, a user can initiate an update of the temporary reception list without waiting for the next modification cycle.

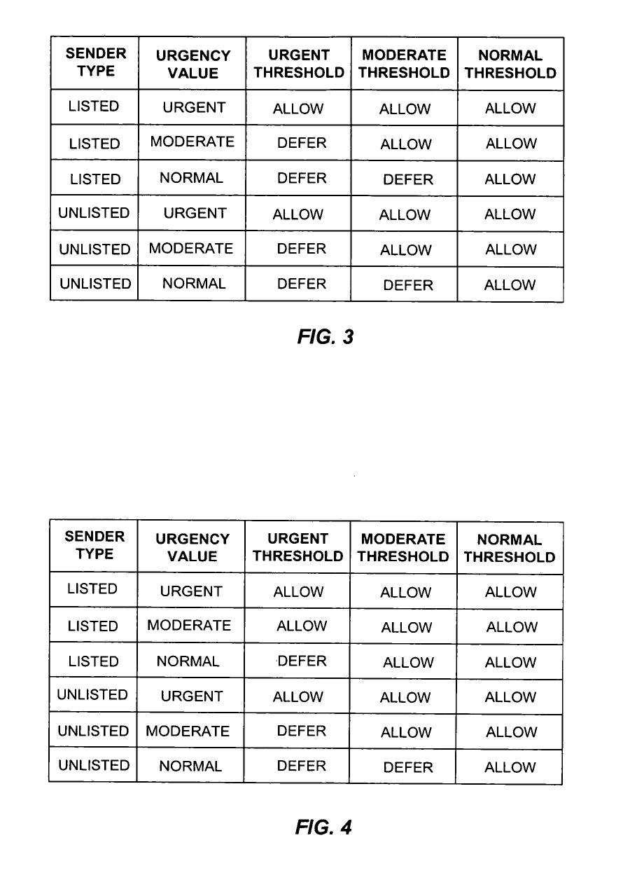

Various levels of urgency can be associated with an interruption generated by a sender. For example, urgency values of “normal” and “moderate” can be assigned for chat requests of low priority and moderate importance, respectively. Urgency values defined as “urgent” can be reserved for the most critical chat requests. The urgency value is compared with the current value of an interruption threshold defined by the user. During times of heavy workload or imminent deadlines, the user may set the interruption threshold value to urgent, causing any interruption request with lower urgency values to be deferred to another medium, such as e-mail. In contrast, under less critical working conditions, the user may set the interruption threshold value to moderate, allowing both urgent and moderate interruptions to occur. FIG. 3 summarizes the processing of interruption request for both listed and unlisted senders according to the user's reception lists for three urgency values.

In one embodiment, senders that are listed in a user's reception list receive an automatic increase in the urgency value of their interruption request during the evaluation of that request. For example, a moderate request from a sender included in the user's reception list is treated the same as an urgent request from an unlisted sender as shown in FIG. 4. Similarly, a normal request from a listed sender is treated equivalent to a moderate request from an unlisted sender.

Many chat and messaging systems provide abbreviated status information to senders of chat requests. The abbreviated status information can be one line of text such as “I AM ACTIVE” or “OUT UNTIL 3:30 PM—SEND CLIENT INFO TO SEAN UNTIL THEN.” Such status information is limited to a single message provided to all status requestors. Thus a user has to consider the potential recipients of the status message when generating the content of the message. The present invention provides for conditional status information to be provided to users. According to one embodiment, the user's reception lists are examined to determine if the sender of an interruption request is included. If the sender is not listed, a generic, non-personal status reply is returned to the sender. However, if the sender is included in at least one of the reception lists, a more detailed message is provided to the sender. For example, an unlisted sender receives the message “OUT UNTIL 10 AM” while a listed sender receives the message “OUT UNTIL 10 AM—AT THE DOCTOR, CALL JOHN FOR CLIENT REPORTS.” Thus personal or work related status information can be made available only to a limited set of status requestors.

Interruption requests can be queued, rather than immediately providing them to the user. The user can disable queuing to allow immediate interruptions or enable complete queuing so that all interruptions are queued without notifying the user. In an embodiment of a method for managing interruptions to a user according to the invention, the user can elect to receive an alert of an interruption request. In one embodiment, the alert can include expanded information about the request, such as identification of the sender and at least a portion (e.g., the first line) of an initial message associated with the request. For example, the alert can include text showing the name of the sender and an urgency value associated with the request. In a second embodiment, the alert can be generic, and the user can consult a constantly-updated table of interruption requests to learn more about the interruption and its requester.

The user can interrogate the request by selecting (i.e., “clicking”) the alert text to determine more (i.e., expanded) information about the sender. If the request is associated with multiple senders, such as request for a multi-party chat, all of the sender names are provided to the user. In one embodiment the request can be previewed to show the entirety of the initial message, including historical message information entered before the current request. The additional information can assist the user in determining whether to respond immediately to the request, for example, by allowing a chat to open. The user has the option of rejecting the interruption without the need for further action. Alternatively, the user can elect to defer the interruption to a lower urgency medium such as e-mail. In another option, the user can propose an alternate medium for response, for example, by receiving the request and returning a request for the sender to telephone the user. In one embodiment the user can respond by issuing a wait message indicating that the user will respond (i.e., chat) after expiration of a time selected by the user.

While the invention has been shown and described with reference to specific embodiments, it should be understood by those skilled in the art that various changes in form and detail may be made therein without departing from the spirit and scope of the invention.

1. A method for managing interruptions to a network user, the interruptions being generated by a plurality of senders on a network, the network user having a permanent reception list the method comprising:
modifying a temporary reception list in response to one of a retrospective activity and a prospective activity;
receiving an interruption from one of the senders on the network;
presenting the interruption to the network user if one of the permanent reception list and the temporary reception list includes an entry associated with the one of the senders on the network.

2. The method of claim 1 wherein modifying the temporary reception list comprises adding an entry to the temporary reception list upon a determination the time until the occurrence of the prospective activity is less than a predetermined time.

3. The method of claim 1 wherein modifying the temporary reception list comprises removing an entry from the temporary reception list upon a determination that the age of the retrospective activity exceeds a predetermined time.

4. The method of claim 1 wherein the retrospective and prospective activities comprise calendar-based entries established by the user.

5. The method of claim 1 wherein the step of presenting the interruption further comprises:
receiving an urgency value associated with the interruption;
comparing the urgency value with an interruption threshold value defined by the network user; and
presenting the interruption to the network user if the urgency value exceeds the threshold value.

6. The method of claim 1 further comprising:
receiving a user status request from one of the senders;
generating a generic status message if the permanent reception list and the temporary reception list do not include an entry associated with the sender of the user status request; and
generating a customized status message if one of the permanent reception list and the temporary reception list includes an entry associated with the sender of the user status request.

7. The method of claim 1 wherein presenting the interruption comprises presenting an alert to the network user if one of the permanent reception list and the temporary reception list includes an entry associated with the one of the senders.

8. The method of claim 7, wherein the alert comprises a signal that an interruption has been requested, and at least one portion of an initial message from one of the senders and an identification of the at least one of the senders is stored in a table for inspection by the user.

9. The method of claim 7, wherein the alert comprises at least one of a portion of an initial message from the one of the senders and an identification of the one of the senders.

10. The method of claim 7 further comprising providing expanded information for the one of the senders to the network user in response to a user request.

11. A computer program product for use with a computer system, the computer program product comprising a computer useable medium having embodied therein program code comprising:
program code for modifying a temporary reception list of a network user in response to one of a retrospective activity and a prospective activity;
program code for receiving an interruption from a sender on the network; and
program code for presenting the interruption to the network user if one of the temporary reception list and a permanent reception list of the network user includes an entry associated with the sender.

12. The computer program product of claim 11 wherein the program code for modifying a temporary reception list further comprises program code for adding an entry to the temporary reception list upon a determination the time until the occurrence of the prospective activity is less than a predetermined time.

13. The computer program product of claim 11 wherein the program code for modifying a temporary reception list further comprises program code for adding an entry to the temporary reception list upon a determination that the time since the occurrence of the retrospective activity is less than a predetermined time.

14. The computer program product of claim 11 wherein the program code for modifying a temporary reception list further comprises program code for removing an entry from the temporary reception list upon a determination that the age of the retrospective activity exceeds a predetermined time.

15. The computer program product of claim 111 wherein the program code for presenting the interruption further comprises:
program code for receiving an urgency value associated with the interruption;
program code for comparing the urgency value with an interruption threshold value defined by the network user; and
program code for presenting the interruption to the network user if the urgency value exceeds the threshold value.

16. The computer program product of claim 11 further comprising:
program code for receiving a user status request from a status requester;
program code for generating a generic status message if the temporary reception list and the permanent reception list do not include an entry associated with the status requester; and
program code for generating a customized status message if one of the temporary reception list and the permanent reception list includes an entry associated with the status requestor.

17. The computer program product of claim 11 wherein the program code for presenting the interruption comprises program code for presenting an alert to the network user if one of the temporary reception list and the permanent reception list includes an entry associated with the sender, the alert comprising at least one of a portion of an initial message from the sender and an identification of the sender.

18. The computer program product of claim 17 further comprising program code for providing expanded information about the sender to the network user in response to a user request.

19. A computer data signal embodied in a carrier wave for use with a computer system having a display and capable of generating a user interface through which a user may interact with the computer system, the computer data signal comprising:
program code for modifying a temporary reception list of a network user in response to one of a retrospective activity and a prospective activity;
program code for receiving an interruption from a sender on the network; and
program code for presenting the interruption to the network user if one of the temporary reception list and a permanent reception list of the network user includes an entry associated with the sender.

20. The computer data signal of claim 19 wherein the program code for modifying a temporary reception list further comprises program code for adding an entry to the temporary reception list upon a determination the time until the occurrence of the prospective activity is less than a predetermined time.

21. The computer data signal of claim 19 wherein the program code for modifying a temporary reception list further comprises program code for removing an entry from the temporary reception list upon a determination that the age of the retrospective activity exceeds a predetermined time.

22. The computer data signal of claim 19 wherein the program code for presenting the interruption further comprises:
program code for receiving an urgency value associated with the interruption;
program code for comparing the urgency value with an interruption threshold value defined by the network user; and
program code for presenting the interruption to the network user if the urgency value exceeds the threshold value.

23. The computer data signal of claim 19 further comprising:
program code for receiving a user status request from a status requester;
program code for generating a generic status message if the temporary reception list and the permanent reception list do not include an entry associated with the status requestor; and
program code for generating a customized status message if one of the temporary reception list and the permanent reception list includes an entry associated with the status requestor.

24. The computer data signal of claim 19 wherein the program code for presenting the interruption comprises program code for presenting an alert to the network user if one of the temporary reception list and the permanent reception list includes an entry associated with the sender, the alert comprising at least one of a portion of an initial message from the sender and an identification of the sender.

25. The computer data signal of claim 24 further comprising program code for providing expanded information about the sender to the network user in response to a user request.

26. A computing system comprising:
a display screen;
a user input device; and
a processor executing a network user communications program to manage interruptions to a network user, the interruptions being generated by a plurality of senders on a network, wherein each interruption is presented to the network user on the display screen if one of a permanent reception list and a temporary reception list includes an entry associated with the respective sender.

27. An apparatus for managing interruptions to a network user, the interruptions being generated by a plurality of senders on a network, the network user having a permanent reception list, the apparatus comprising:
means for modifying a temporary reception list in response to one of a retrospective activity and a prospective activity;
means for receiving an interruption from one of the senders on the network;
means for presenting the interruption to the network user if one of the permanent reception list and the temporary reception list includes an entry associated with the one of the senders on the network.

28. The apparatus of claim 27 wherein the means for modifying the temporary reception list comprises means for adding an entry to the temporary reception list upon a determination the time until the occurrence of the prospective activity is less than a predetermined time.

29. The apparatus of claim 27 wherein the means for modifying the temporary reception list comprises means for removing an entry from the temporary reception list upon a determination that the age of the retrospective activity exceeds a predetermined time.

30. The apparatus of claim 27 wherein the means for presenting the interruption further comprises:
means for receiving an urgency value associated with the interruption;
means for comparing the urgency value with an interruption threshold value defined by the network user; and
means for presenting the interruption to the network user if the urgency value exceeds the interruption threshold value.

31. The apparatus of claim 27 further comprising:
means for receiving a user status request from one of the senders;
means for generating a generic status message if the permanent reception list and the temporary reception list do not include an entry associated with the sender of the user status request; and
means for generating a customized status message if one of the permanent reception list and the temporary reception list includes an entry associated with the sender of the user status request.

32. The apparatus of claim 27 wherein the means for presenting the interruption comprises presenting an alert to the network user if one of the permanent reception list and the temporary reception list includes an entry associated with the one of the senders, the alert comprising at least one of a portion of an initial message from the one of the senders and an identification of the one of the senders.

33. The apparatus of claim 32 further comprising means for providing expanded information for the one of the senders to the network user in response to a user request.
